(19) United States
(12) Patent Application Publication
(10) Pub. No.: US 2009/0179010 A1
(43) Pub. Date: Jul. 16, 2009

(54) ABLATIVE-BASED CURRENT INTERRUPTER

(76) Inventors: THANGAVELU ASOKAN, KARNATAKA (IN); SUNIL SRINIVASA MURTHY, TAMIL NADU (IN); KUNAL RAVINDRA GORAY, KARNATAKA (IN); NIMISH KUMAR, JHARKHAND (IN); ADNAN KUTUBUDDIN BOHORI, KARNATAKA (IN)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/971,999

(22) Filed: Jan. 10, 2008

(51) Int. Cl. H01H 33/02

(52) U.S. Cl. 218/157

(57) ABSTRACT

Apparatus for interrupting an electrical current between two contacts, such as a first contact and a second contact, is provided. The first and second contacts are separable away from one another to interrupt electrical current flowing between the contacts. An ablative chamber is disposed around the contacts. The chamber includes an ablative material that discharges a vapor when an electrical arc is generated in an arc zone during a separation of the contacts. A venting arrangement is provided in the ablative chamber. The venting arrangement is distributed along the arc zone to influence at least one parameter in the ablative chamber during an arc quenching event. The parameter is selected to affect at least one arcing characteristic.

### FIELD OF THE INVENTION

Embodiments of the present invention are generally related to electrical arc quenching in current interruption devices, and, more particularly, to ablative-based electrical arc quenching, and, even more particularly, to structural arrangements for enhancing the current interruption performance by balancing physical conditions that affect arcing characteristics, as such conditions develop during an arc quenching event in an ablative chamber.

### BACKGROUND OF THE INVENTION

A variety of devices are known and have been developed for interrupting current between a source and a load. Circuit breakers are one type of device designed to trip upon occurrence of heating or over-current conditions. Other circuit interrupters trip either automatically or by implementation of a tripping algorithm, such as to limit current to desired levels, limit power through the device in the event of phase loss or a ground fault condition. In general, such devices include one or more moveable contacts, which separate from mating contacts to interrupt a current carrying path.

Performance of a circuit interrupter is typically dictated by a peak let through current, which is in turn controlled by a rate of arc voltage development across the contacts as the contacts are moved away from one another during a circuit interruption event. Accordingly, improvement of circuit interrupter performance has focused on more rapidly increasing arc voltage development to limit a peak let though current. A wide range of techniques has been employed for improving interruption times to limit the let-through energy, such as by providing faster contact separation. The arc voltage may be made to rise very quickly to cause a corresponding rapid interruption of the current. Another technique used to limit the let-through energy is to provide arc dissipating structures, such as conductive plates arranged with air gaps between each plate, commonly known as an arc chute. Entry of the arc into such structures may assist in extinguishing the arc and thereby limit the let-through energy during circuit interruption.

### BRIEF DESCRIPTION OF THE INVENTION

Generally, aspects of the present invention provide an apparatus for interrupting an electrical current between two contacts, such as a first contact and a second contact. The first and second contacts are separable away from one another to interrupt electrical current flowing between the contacts. An ablative chamber is disposed around the contacts. The chamber includes an ablative material thereon that discharges a vapor when an electrical arc is generated in an arc zone during a separation of the contacts. A venting arrangement is provided in the ablative chamber. The venting arrangement is distributed along the arc zone to influence at least one parameter in the ablative chamber during an arc quenching event. This at least one parameter is selected to affect at least one arcing characteristic.

Further aspects of the present invention provide an apparatus for interrupting an electrical current between two contacts, such as a first contact and a second contact. The first and second contacts are separable away from one another to interrupt electrical current flowing between the contacts. An ablative chamber is disposed around the contacts. The chamber includes an ablative material thereon that discharges a vapor when an electrical arc is generated in an arc zone during a separation of the contacts. A venting arrangement is provided in the ablative chamber. An internal geometry of the ablative chamber and a spatial distribution of the venting arrangement along the arc zone are selected to jointly influence at least one parameter in the ablative chamber during an arc quenching event. This at least one parameter is selected to affect at least one arcing characteristic.

### BRIEF DESCRIPTION OF THE DRAWINGS

FIG. 1 shows a partial cross sectional schematic view of an example embodiment of an ablative-based circuit interrupter in a current conducting mode.

FIG. 2 shows a partial cross sectional schematic view of the example embodiment of the circuit interrupter of FIG. 1 at a beginning of a current interruption mode.

FIGS. 3-6 and 9 each illustrates a respective schematic of an example circuit breaker as may be based on a circuit interrupter having an ablative chamber with a venting arrangement configured in accordance with aspects of the present invention.

FIGS. 7-8 and 10 each illustrates respective schematic of an example circuit breaker as may be based on a circuit interrupter having a respective ablative chamber a respective venting arrangement jointly configured in accordance with aspects of the present invention.

### DETAILED DESCRIPTION OF THE INVENTION

FIG. 1 shows a partial cross sectional schematic view of an example of an ablative-based circuit interrupter 10 in a current conducting mode. The circuit interrupter 10 may include a first conducting element, or first contact 12, having a contacting end portion 14, and a second conducting element, or second contact 16, having a respective contacting end portion 18. When the contacts 12, 16 are positioned in electrical contact with one another, such as when the contacting end portions are abutting, an electrical current may be conducted between the elements 12, 16. The first contact 12 and second contact 16 may be separable away from one another to interrupt an electrical current flowing between them. For example, the second contact 16 may be movable out of electrical contact with the first contact 12 to interrupt the electrical current, the first contact 12 may be movable out of electrical contact with the second contact 16 to interrupt the electrical current, or both contacts 12, 16 may be movable out of electrical contact with each other to interrupt the electrical current.

As shown in FIG. 2, the circuit interrupter 10 includes an arc zone 20 where an electrical arc discharge may occur when electrical contacts 12 and/or 16 move to interrupt the current. Arc zone 20 may be disposed around the contacts 12, 16, such as around respective end portions 14, 18 of the contacts 12, 16. Arc zone 20 may be defined by a wall 22 in an aperture formed in an insulator 24, such as, but not limited to, a ceramic plate, a polymer plate, a plastic composite plate or combination of these material, disposed around the contacts 12, 16.

An ablative material 28 may be disposed in the arc zone 20 for producing an increased pressure in arc zone 20, such as may contribute to force separation of the contacts 12, 16. The increased pressure may be generated in response to an arc 32 formed between the contacts 12, 16. When the contacts 12, 16 are initially separated from being in electrical contact as shown in FIG. 2, the arc 32 formed in the arc zone 20 there between generates gases (e.g., vapors) in part by the heat and/or radiation generated by the arc 32 acting on the ablative material 28 lining the walls 22. The vapor generated by the ablating process in turn causes a pressure increase in the arc zone 20 resulting in force acting on the contacts 12, 16 to move at least one of the contacts (e.g., 16) away from the other contact 12 and out of arc zone 20 at an end of a current interruption mode.

As shown in FIG. 2, the ablative material 28 may be configured to line a wall 22 of arc zone 20 around the end portions 14, 18 of the contacts 12, 16. The ablative material 28 may abut the sides 19 of the contacts 12, 16, or may be spaced away a sufficiently small clearance distance, D, to achieve a desired reduced let-through current limiting performance. The ablative material 28 may include polymers such as polytetrafluoroethylene (PTFE), polyethylene, polyimide, polyamide, or polyoxymethylene (POM), epoxide, polyester, polypropylene, poly methyl-methacralate, poly acetal, polysulphones, phenolic resin, phenolic resin composite, polyetherimide, polyether ketone, polypropylene sulphide-based polymers. Such polymers may also include organic and/or inorganic fillers and/or additives to achieve, for example, desired ablating properties. In an embodiment, the ablative material 28 may comprise a tubular insert disposed in the aperture. The preceding description may be viewed as foundational description as may be broadly applicable to any generic ablative-based current interrupter and will now proceed to describe example embodiments of the circuit interrupter 10 configured in accordance with aspects of the present invention. For readers desirous of further background information in connection with further examples of ablative-based current interrupters, reference is made to U.S. patent application Ser. No. 11/289,933, assigned to the same assignee of the present invention and herein incorporated by reference in its entirety.

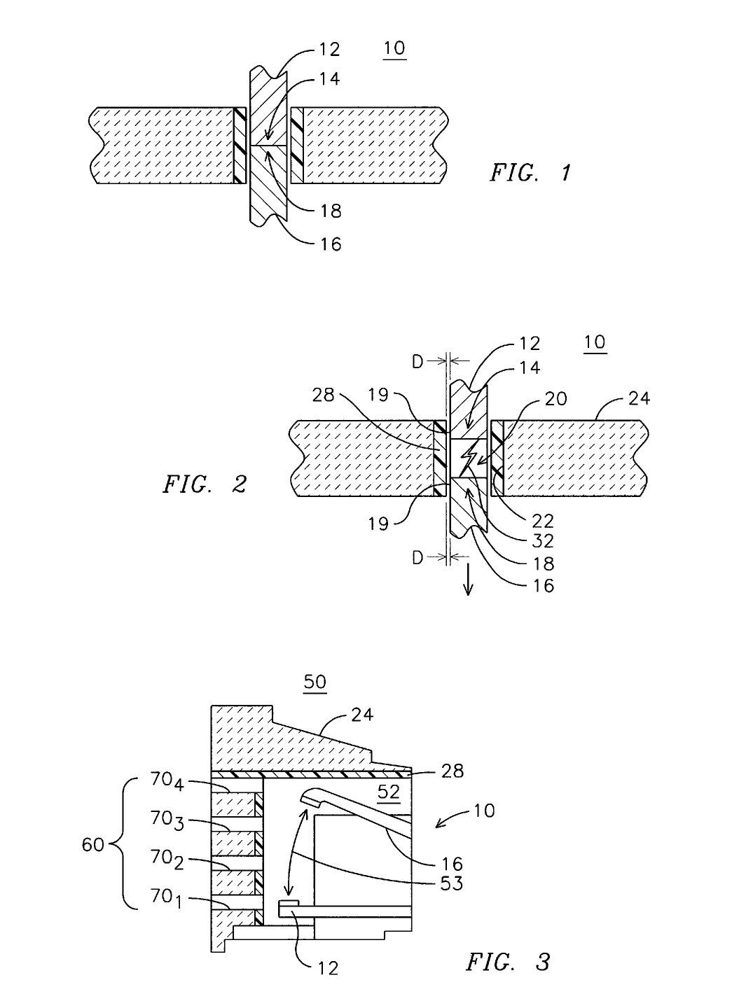

FIG. 3 illustrates a schematic of an example circuit breaker 50 as may be based on an embodiment of the circuit interrupter 10 configured in accordance with aspects of the present invention. The circuit breaker 50 includes a circuit interrupter 10 comprising a stationary contact 12 and a movable contact 16 disposed in an ablative chamber 52 in breaker 50. The movable contact 16 is movable (as conceptually represented by arrow 53) into and out of electrical contact with stationary contact 12, so that when the contacts 12, 16 are positioned in electrical contact, electrical power is provided to an electrical load (not shown). The walls in ablative chamber 52 may be lined with an ablative material 28, such as PTFE or other ablative material described previously. The movable contact 16 is moveable to provide circuit interrupting performance as described above. A venting arrangement 60 in fluid communication with ablative chamber 52 is provided in accordance with aspects of the present invention to discharge vapor emissions generated by the ablative material 28 during an arc quenching event in ablative chamber 52, as may occur during a circuit interruption action to suppress a fault current.

The inventors of the present invention have discovered that the geometric configuration of the ablative chamber and/or a distribution of the venting arrangement along the arc zone may substantially influence the performance of a circuit interrupter based on ablative arc quenching. As explained in further detail below, aspects of the present invention are directed to structural arrangements for balancing one or more physical conditions or parameters that can affect arcing characteristics, as can arise during an arc quenching event in ablative chamber 52. An example of such a physical condition may be a pressure buildup in the ablative chamber. The pressure in the ablative chamber can affect one or more characteristics of the electrical arc, (e.g., arc resistance, arc cooling) and consequently can affect the level of let-through current associated with an electrical arcing event.

The description that follows will focus on some of the basic physical underpinnings in connection with ablative-based arc quenching. As soon as an electrical arc is discharged, nonionized ablative vapors are formed in the ablative chamber, e.g., due to radiation. These nonionized ablative vapors lead to a pressure increase which is conducive to ionization of the initially nonionized ablative vapors. It is noted that the energy required for ionization is taken from the electrical arc. That is, the non-ionized ablative gases absorb energy from the electrical arc and consequently the arc is left with lesser energy and this leads to a desirable arc cooling. However, a buildup in the amount of ionized gases can lead to pressure increase of the ionized gases, which in turn can lead to a lower arc impedance (e.g., resistance) and may result in an undesirable increment of arc current flow. Thus, aspects of the present invention recognize the need to appropriately balance such counter-opposing effects and provide a practical and relatively low-cost implementation tailored to achieve such objectives. For example, one would like to establish an structural arrangement (e.g., internal chamber geometry and/or venting arrangement) where the physical conditions (e.g., an initial pressure buildup) in the chamber are conducive to the ionization of the non-ionized ablative vapors, followed by a rapid venting out of the ionized gases. This process would continue with a generation of fresh non-ionized ablative vapors followed by ionization and venting out. This process of ablative vapor generation, followed by ionization and venting out would be repeated along the arc zone as the movable contact travels away from the stationary contact till the arc is quenched.

Returning to FIG. 3, it can be appreciated that venting arrangement 60 is made up of a plurality of spaced-apart vents 70₁-70₄ distributed (e.g., staggered) along the arc zone. Essentially, venting arrangement 60 consists of a pattern consisting of a vent (e.g., vent 70₁) followed by an adjacent structure followed by another vent, (e.g., vent 70₂), followed by another adjacent structure, etc., so that the overall cross-section provided by vents 70₁-70₄ is less than the cross-section that would be provided by a fully unimpeded vent extending along the arc zone. Each structure interposed between adjacent vents may be viewed to provide certain amount of venting restriction conducive to a pressure buildup therein for an incremental cooling of the arc due to ionization of the vapor. Conversely, each vent opening may be viewed as conducive to a release of ionized vapor, as may cause a desirable increment in the impedance value of the electrical arc.

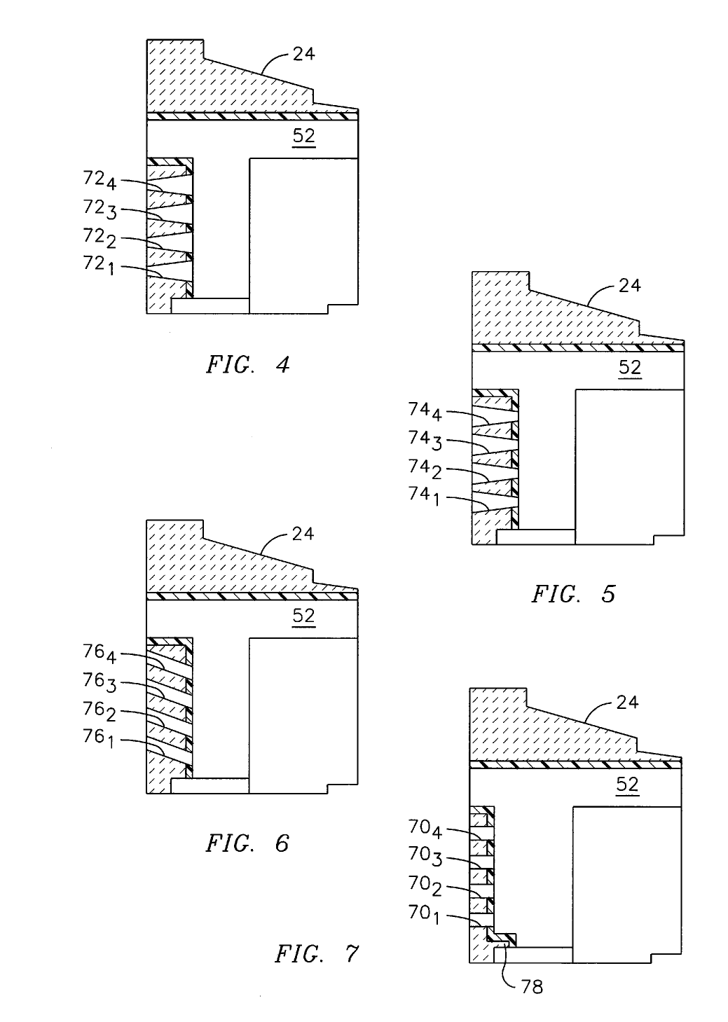

The foregoing arrangement is an example embodiment consistent with the physical underpinnings described above in connection with an appropriate balance of the alluded to counter-opposing effects, such as providing certain level of venting restriction (e.g., for initial pressure buildup) to facilitate ionization and concomitant arc cooling, while still providing suitable venting to discharge ionized vapors and reduce the possibility of an increase in arc resistance. It will be appreciated that this example embodiment is limited neither to the specific number of vents shown in FIG. 3 nor to the specific geometry shown in FIG. 3. For example, in lieu of the parallel arrangement of straight-thru vents 70₁-70₄, as shown in FIG. 3, one may provide an arrangement of convergent vents 72₁-72₄ staggered along the arc zone, as shown in the example embodiment of FIG. 4. That is, vents 72₁-72₄ having a continuous reduction in their cross sectional area as the vents extend away from ablative chamber 52.

Another example embodiment may be an arrangement of divergent vents 74₁-74₄ staggered along the arc zone, as shown in the example embodiment of FIG. 5. That is, vents 74₁-74₄ having a continuous increase in their cross sectional area as the vents extend away from ablative chamber 52. Still another example embodiment may be an arrangement of angled vents 76₁-76₄, as shown in the example embodiment of FIG. 6.

In FIG. 7, the venting arrangement includes a plurality of straight-thru vents 70₁-70₄ staggered along the arc zone, and which vents in combination function as described in the context of FIG. 3. In this example embodiment, a step 78 is provided within ablative chamber 52 proximate stationary contact 12. Step 78 in essence provides a reduction in volume at the lower portion of the ablative chamber. This reduction in volume is conducive to an incremental boost in pressure conducive to incremental ionization of ablative gases and concomitant arc cooling.

In FIG. 8, the venting arrangement includes a plurality of straight-thru vents 70₁-70₄ distributed along the arc zone, and which vents in combination function as described in the context of FIG. 3. In this example embodiment, ablative chamber 52 is in part defined by a tapered wall 80. That is, a width W of the ablative chamber in lieu of being a constant width along the arc zone, such a width W consists of a varying width. That is, tapered wall 80 provides a continuous decrease in the ablative chamber volume as the movable contact travels away from the fixed contact. Experimental results indicate that this combination of continuously decreasing chamber volume along with staggered vents 70₁-70₄ provides superior performance with respect to arc cooling. An optional upper vent 82 (shown in dashed lines) may be provided if one desires to decrease the peak pressure that may develop in the ablative chamber during an arc quenching event.

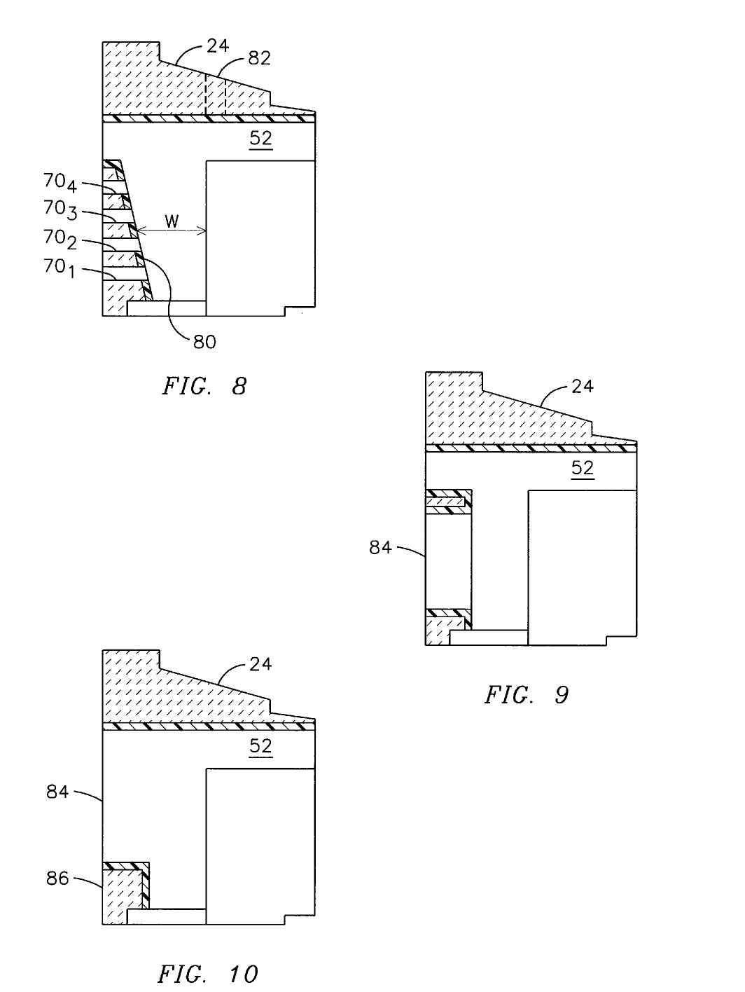

FIG. 9 illustrates a venting arrangement made up of a vent 84 with an opening substantially extending along the arc zone. As may be expected from the above-discussed physical underpinnings, a fully open vent may not necessarily be conducive to a sufficient pressure buildup for efficient ionization of the ablative vapors, as may be desired for efficient arc cooling and this was confirmed with experimental results. An addition of a step 86 within ablative chamber 52 as shown in FIG. 10 did not substantially improve operational performance as compared to the described embodiments that involve a partial restriction along the arc zone, such as may be provided with a staggering of vents.

While certain embodiments of the present invention have been shown and described herein, such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. An apparatus for interrupting an electrical current between two contacts comprising:
a first contact;
a second contact, the first and second contacts being separable away from one another to interrupt electrical current flowing between the contacts;
an ablative chamber disposed around the contacts, said chamber having an ablative material thereon that discharges a vapor when an electrical arc is generated in an arc zone during a separation of the contacts; and
a venting arrangement in the ablative chamber, the venting arrangement distributed along the arc zone to influence at least one parameter in the ablative chamber during an arc quenching event, said at least one parameter selected to affect at least one arcing characteristic.

2. The apparatus of claim 1, wherein said venting arrangement comprises a plurality of vents spaced apart along the arc zone, wherein said venting arrangement provides at least one venting restriction disposed proximate a first section of the chamber, said at least one venting restriction conducive to a pressure buildup therein for an incremental cooling of the arc due to ionization of the vapor.

3. The apparatus of claim 2, wherein said venting arrangement provides at least one opening disposed proximate a second section of the chamber, said at least one opening conducive to a release of ionized vapor to cause an increment in an impedance value of the electrical arc.

4. The apparatus of claim 3, wherein the first and second sections of the chamber are adjacent to one another.

5. The apparatus of claim 3, wherein said plurality of spaced apart vents comprises a parallel arrangement of vents.

6. The apparatus of claim 3, wherein said plurality of spaced apart vents comprises at least one vent having a uniform cross-sectional venting area along a respective longitudinal axis of said at least one vent.

7. The apparatus of claim 3 wherein said plurality of spaced apart vents comprises at least one vent having a varying cross-sectional venting area along a respective longitudinal axis of said at least one vent.

8. The apparatus of claim 7, wherein the varying cross-sectional venting area decreases as the vent extends away from the ablative chamber along the respective longitudinal axis.

9. The apparatus of claim 7, wherein the varying cross-sectional venting area increases as the vent extends away from the ablative chamber along the respective longitudinal axis.

10. The apparatus of claim 3, wherein said plurality of spaced apart vents comprises a plurality of vents each extending at an angle relative to a horizontal line.

11. The apparatus of claim 1, wherein an internal geometry of the ablative chamber is selected to further influence said at least one parameter in the ablative chamber during the arc quenching event.

12. The apparatus of claim 11, wherein the first contact is movable and the second contact is stationary.

13. The apparatus of claim 1, wherein an internal geometry of the ablative chamber comprises a constant volume of the chamber along the arc zone.

14. The apparatus of claim 12, wherein the internal geometry of the ablative chamber is configured to provide an increasing volume of the chamber as the moveable contact travels away from the stationary contact during the arc quenching event.

15. The apparatus of claim 14, wherein the internal geometry of the chamber configured to provide the increasing chamber volume is defined by a wall of the ablative chamber having a taper.

16. The apparatus of claim 12, wherein the internal geometry of the ablative chamber is configured to define a step disposed proximate the stationary contact, said step providing a volumetric reduction that causes a pressure buildup therein for an incremental cooling of the arc due to ionization of the vapor.

17. The apparatus of claim 1, wherein the first contact and second contact are each movable away from one another.

18. An apparatus for interrupting an electrical current between two contacts comprising:
a first contact;
a second contact, the first and second contacts being separable away from one another to interrupt electrical current flowing between the contacts;
an ablative chamber disposed around the contacts, said chamber having an ablative material thereon that discharges a vapor when an electrical arc is generated in an arc zone during a separation of the contacts; and
a venting arrangement in the ablative chamber, wherein an internal geometry of the ablative chamber and a spatial distribution of the venting arrangement along the arc zone are selected to jointly influence at least one parameter in the ablative chamber during an arc quenching event, said at least one parameter selected to affect at least one arcing characteristic.

19. The apparatus of claim 18, wherein said at least one parameter consists of a pressure buildup in the chamber for causing an incremental cooling of the arc due to ionization of the vapor.

20. The apparatus of claim 19, wherein said venting arrangement provides at least one opening conducive to a release of ionized vapor formed during the pressure buildup to cause an increment in an impedance value of the electrical arc.
